(19) United States
(12) Patent Application Publication
(10) Pub. No.: US 2010/0211489 A1
(43) Pub. Date: Aug. 19, 2010

(54) CONTENT MANAGEMENT AND DELIVERY SYSTEM

(75) Inventors: Binzhen Zhang, Singapore (SG); Kum Shiong Chong, Singapore (SG)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INTRACO TECHNOLOGY PTE LTD, Singapore (SG)

(21) Appl. No.: 12/669,985

(22) PCT Filed: Jul. 17, 2008
(86) PCT No.: PCT/SG2008/000256

§ 371 Date: Jan. 21, 2010

Related U.S. Application Data
(60) Provisional application No. 60/951,818, filed on Jul. 25, 2007.

(51) Int. Cl. G06F 3/01; G06F 15/16; G06F 21/20; G06Q 30/00; G06Q 50/00

(52) U.S. Cl. 705/34; 715/702; 726/12

(57) ABSTRACT

A content management and delivery system comprising a plurality of communication devices and a content server is provided. Each of the plurality of communication devices has a display panel for enabling haptic interaction with data displayed thereon. The content server is coupled to the plurality of communication devices. At least one of the plurality of communication devices is to receive the data from the content server, generate a response corresponding to a user interaction with the data displayed on the display panel and transmit the response to the content server. The data is customizable to provide a plurality of user selectable options for facilitating user interaction therewith.

### BACKGROUND

1. Technical Field

This invention generally relates to multimedia content delivery systems. Particularly, but not exclusively, it pertains to a multimedia content delivery server coupled to network-couplable phone appliances with touch-sensitive screens.

2. Description of Related Art

Hotels typically offer a wide range of services for their guests. Examples of types of services available include ordering meals from hotel restaurants, ordering spa and massage services, booking conference rooms for meetings, providing morning wakeup-call reminders, suggesting travel itineraries and the like. Often, the hotels provide a services-menu booklet in every hotel room, listing the types and associated costs of available services which the guests may order. Generally, a request for any of the listed services involves a guest instructing an operator through a phone provided in a hotel room, who will then relay the instructions to the respective departments providing the requested service.

Although such a method of requesting for the services is widely practiced by the service and hospitality industry, there are several problems to the method. One problem is a need to always assign at least one hotel staff on-site to act as an operator to receive instructions from the guests. Another problem is the propensity for miscommunication between the operator and guests.

### SUMMARY

Embodiments of the invention disclosed herein provide a content management and delivery system for distributing multimedia content to network-couplable communication devices.

According to an embodiment of the invention, there is provided a content management and delivery system comprising a plurality of communication devices and a content server. Each of the plurality of communication devices has a display panel for enabling haptic interaction with data displayed thereon. The content server is coupled to the plurality of communication devices. At least one of the plurality of communication devices is to receive the data from the content server, generate a response corresponding to a user interaction with the data displayed on the display panel and transmit the response to the content server. The data is customizable to provide a plurality of user selectable options for facilitating user interaction therewith.

According to another embodiment of the invention, there is provided a content management and delivery method comprising displaying data on a display panel of at least one of a plurality of communication devices. The display panel enables haptic interaction with the data displayed thereon and the plurality of communication devices is coupled to a content server. Additionally, the data is received from the content server. The method also comprises generating a response corresponding to a user interaction with the data displayed on the display panel and transmitting the response to the content server. The data is customizable to provide a plurality of user selectable options for facilitating user interaction therewith.

According to a further embodiment of the invention, there is provided a computer-program product, comprising a computer readable storage medium and a computer program mechanism embedded therein, the computer program mechanism comprising instructions, which when executed by a communication device, cause the device to display data on a display panel thereof. The display panel enables haptic interaction with the data displayed thereon and the communication device is coupled to a content server. Additionally, the data is received from the content server. The instructions also cause the communication device to generate a response corresponding to a user interaction with the data displayed on the display panel and then transmit the response to the content server. The data is customizable to provide a plurality of user selectable options for facilitating user interaction therewith.

### BRIEF DESCRIPTION OF THE DRAWINGS

Embodiments of the invention are disclosed hereinafter with reference to the drawings, in which:

FIG. 1 illustrates a schematic diagram of a content management and delivery system used in conjunction with phone appliances for deployment in an establishment, such as a hotel, in accordance with a preferred embodiment of the invention;

FIG. 2 illustrates a relational diagram between the content manager of the content management and delivery system of FIG. 1 and various service categories;

FIG. 3 is a floor plan of a hotel room showing a typical arrangement of a plurality of phones provided in a hotel room;

FIG. 4 is a right side perspective view of a network-couplable phone appliance for use in conjunction with the content management and delivery system of FIG. 1;

FIG. 5 is a left side perspective view of the phone appliance;

FIG. 6 is a top plan view of the phone appliance;

FIG. 7 is a screen-capture of a display page for ordering room-service via the phone appliance;

FIG. 8 is a screen-capture of a display page for ordering spa and massage services via the phone appliance;

FIG. 9 is a screen-capture of a display page for composing an email message via the phone appliance;

FIG. 10 is a screen-capture of a display page for controlling lighting conditions in a hotel room via the phone appliance;

FIG. 11 is a screen-capture of a display page for tuning into Internet radio services via the phone appliance;

FIG. 12 is a screen-capture of a display page for showing the weather forecast via the phone appliance;

FIG. 13A is a screen-capture of the administrator login page for the management portal of the content manager of FIG. 2;

FIG. 13B is a screen-capture of the main display page of the management portal of the content manager of FIG. 2;

FIG. 14 is a screen-capture of a display page for managing digital signages located within the hotel;

FIG. 15 is a screen-capture of a display page for managing the list of available portal services;

FIG. 16 is a screen-capture of a display page for managing the selection of available services provided by the hotel;

FIG. 17 is a screen-capture of a display page for indicating a current room status of each hotel room;

FIG. 18 is a screen-capture of a display page for showing a summary listing of room status of all the hotel rooms;

FIG. 19 is a screen-capture of a display page for managing events that are hosted within the hotel; and

FIG. 20 is a flow diagram illustrating an exemplary user authentication method for granting Internet access to computing devices employing the phone appliance as an Internet wireless access point (WAP) in accordance with some embodiments.

### DETAILED DESCRIPTION

Reference will now be made in detail to embodiments of the invention, examples of which are illustrated in the accompanying drawings. In the following detailed description, numerous specific details are set forth in order to provide a thorough understanding of the invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments. In the drawings, like reference numerals refer to like elements or functionalities throughout the several presented views.

It will also be understood that, although the terms first, second and etc. may be used herein to describe various elements, these elements should not be limited by these terms. These terms are only used to distinguish one element from another, without departing from the scope of the invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

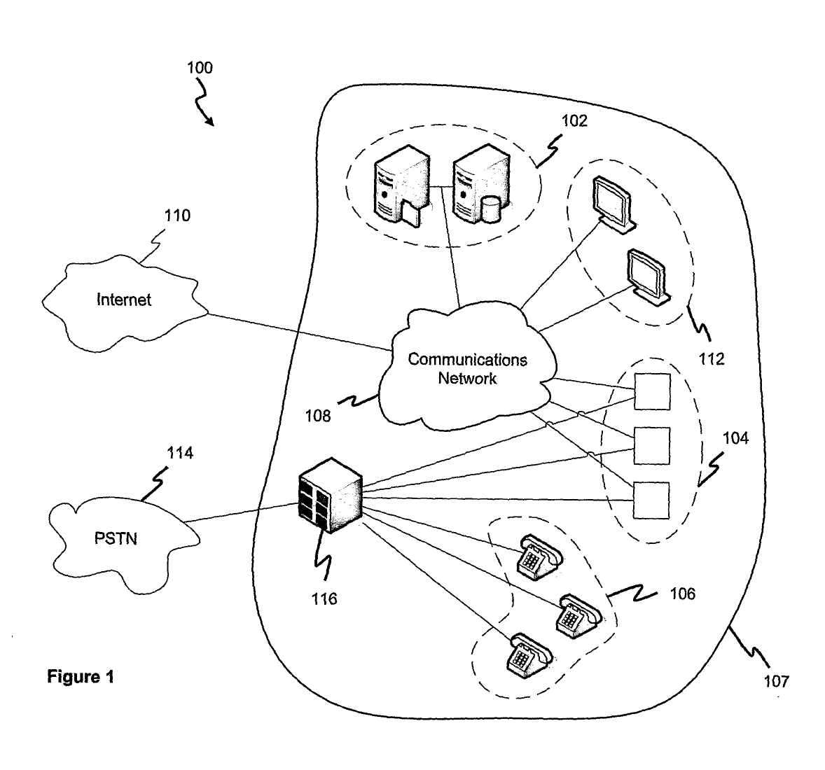

Embodiments of a content management and delivery system 100 (hereinafter as “CMD system”) as shown in FIG. 1 together with phone appliances used in conjunction therewith, user interfaces for such devices, and associated processes for using such devices are described herein. In exemplary embodiments, the CMD system 100 is described for use in reference with the service and hospitality industry. In other embodiments, the CMD system 100 coupled with suitable modifications, is applicable for use by other establishments such as hospitals, service apartments and the like.

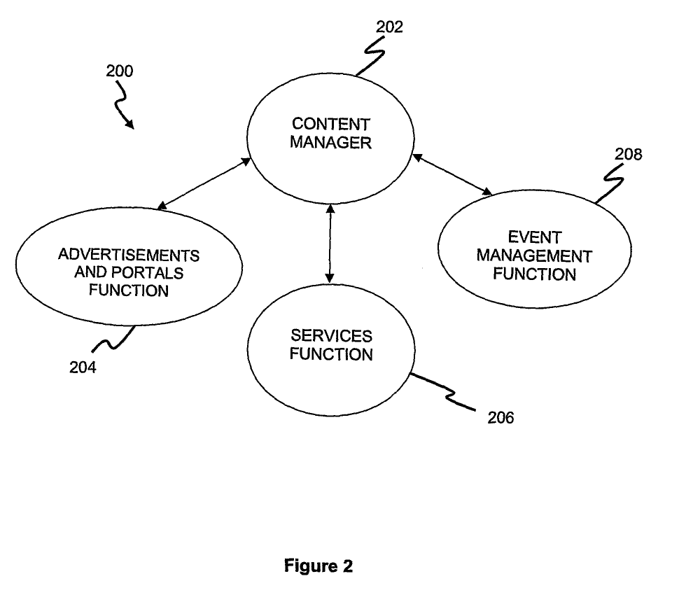

The CMD system 100 comprises a content database manager 102 and a plurality of phone appliances 104 (hereinafter as “interactive phones”). The content database manager 102 may be installed with a software management suite known as the content manger 202, as depicted in FIG. 2, for managing interactive contents stored therein that are broadcasted to the interactive phones 104. Notably, the interactive contents may include advertisements, electronic messages, information, video clips, multimedia files and the like. The interactive phones 104 together with conventional analog phones 106 may be provided to users in an establishment 107 such as a hotel. Further, it is to be understood from hereon, the usage of the CMD system 100 is described herein with reference to a hotel environment.

The content database manager 102 and the interactive phones 104 are communicably coupled via a communications network 108 as shown in FIG. 1. The communications network 108 is an internal network (i.e. intranet) located within the hotel. Moreover, the communications network 108 is preferably an Internet Protocol (IP) based network which facilitates connection to and access of the Internet 110 by the interactive phones 104. The interactive phones 104 may connect to the communications network 108 using a variety of broadband networking technologies such as broadband over power lines (BPL), cable modem connection or x-digital subscriber lines (xDSL). xDSL comprises an entire family of variant DSL-based technologies such as asymmetric-DSL (ADSL), symmetric-DSL (SDSL) or very-high-speed-DSL (VDSL). Furthermore, the connection establishment from the communications network 108 to the Internet 110 may also be made via a variety of connections such as BPL, cable modem connection or xDSL.

The communications network 108 also allows digital signages 112 (e.g. plasma TV displays, liquid crystal display (LCD) displays or organic light-emitting diode (OLED) displays) located within the hotel to be connected thereto. In this way, advertisements or information may quickly be disseminated by the hotel management whenever necessary. The interactive phones 104 also comprise means for making telephone calls using the plain old telephone system (POTS) by connecting to conventional analog public switched telephone networks 114 (PSTN) through a private automatic branch exchange 116 (PABX) provided in the hotel. Additionally, in another embodiment, besides connecting to the communications network 108 via the afore-described broadband networking technologies, the interactive phones 104 may also connect thereto through the PSTN 114. Furthermore, the PSTN 114 also connects the analog phones 106 in the hotels to each other. Consequently, the guests may use the interactive phones 104 to make telephone calls either via the PSTN 114 or via packet-based technologies such as voice-over-IP (VoIP).

With reference to FIG. 2, the content manager 202 comprises an advertisements-and-portal function 204, a services function 206 and an event management function 208. The advertisements-and-portals function 204 generally performs one or more of the following: storing and managing advertisement video clips, streaming text and images; advertisements selection, arranging display sequence and mode of display; updating portals for online services; and transmitting guests' selections to external service providers. Independently, the services function 206 generally performs one or more of the following: updating of hotel service directories; updating room service menus; transmitting guests' selections to relevant service providers; updating room status information for management of housekeeping services; monitoring guests' incurred expenses; and generating status and billing reports/receipts (e.g. for room status, accrued expenses and the like). The event management function 208 generally performs one or more of the following: providing a service portal for conference management; defining guest groups and customizing online services for specific guest groups.

In addition, the content manager 202 is adapted for a variety of content management and delivery functions, including but not limited to, customizing contents for display on the interactive phones 104, storing data retrieved from the interactive phones 104, receiving inputs from the interactive phone 104, and generating management and billing reports/receipts. The content manager 202 is also used for customizing display attributes (e.g. display sequences) of the advertisements/information that are scheduled for display on the digital signages 112 in the hotel.

Various levels of access privileges to the CMD system 100 may be defined for and assigned to different groups of authorized users. For instance, content administrators may be granted full access to the CMD system 100 whereas housekeeping personnel may only access the room status page while an event coordinator may only access the event management page.

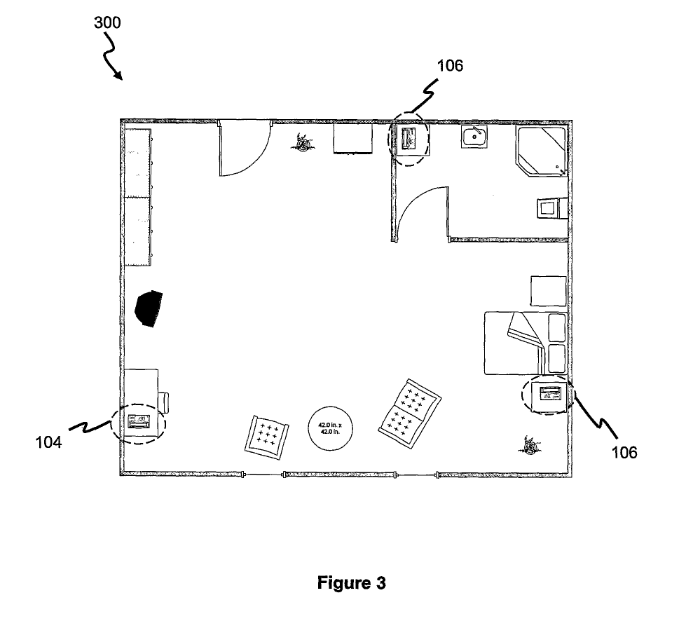

FIG. 3 shows a floor plan of a hotel room 300 in the hotel in which a typical arrangement of phones installed in the hotel room 300 is as illustrated. In the hotel room 300, the phones as shown include an interactive phone 104 and two analog phones 106. With reference to the interactive phone 104, besides allowing the guest to make phone calls and interacting with the interactive contents displayed thereon, the interactive phone 104 may also serve as an Internet wireless access point (WAP) for computing devices (not shown) such as cellular phones, computers and mobile computing devices. Mobile computing devices may include personal-digital-assistants (PDAs), smartphones, Tablet PCs, laptops, ultra-mobile PCs (UMPC), mobile Internet devices (MID) and the like. Hence, the computing devices are able to connect to and access the Internet 110 through the interactive phone 104.

When a guest wishes to access the Internet 110 from his computing device with the intent of employing the interactive phone 104 as an Internet WAP, the interactive phone 104 may further be employed as an authentication gateway. This is necessary because usage of Internet access in a hotel is typically chargeable to the guests. Hence, user authentication is typically required to establish the identities of the guests and facilitate subsequent billing of the guests. More particularly, the guests are to be ascertained as legitimate room guests staying with the hotel before Internet access may be granted. User authentication is carried out using security systems employing authentication protocols and procedures as known in the art.

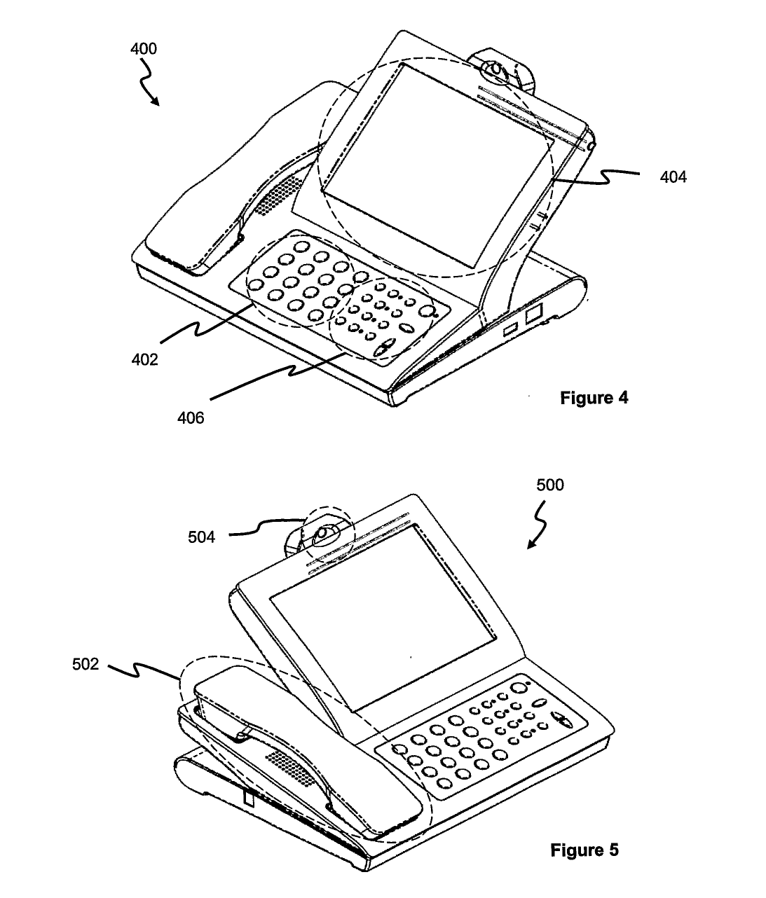

With reference to FIGS. 4 to 6, various views 400, 500, 600 of the interactive phone 104 are as illustrated. The interactive phone 104 includes a housing which comprises alpha-numeric buttons 402, a display panel 404 and function buttons 406. The alpha-numeric buttons 402 can be used to make a phone call or access and/or retrieve information from the content database manager 102 and display the information on the display panel 404. The function buttons 406 may comprise a mute button, a hold button, a redial button, volume adjustment buttons and an activate-speaker button. A call-mode-switch activation button may also be provided for users to select between making telephone calls as conventional analog calls or VoIP calls.

The interactive phone 104 may be installed with an operating system (e.g. Darwin, RTXC, LINUX, UNIX, OS-X, WINDOWS, or an embedded operating system such as VxWorks) which includes various software components and/or drivers for controlling and managing general system tasks (e.g. memory management, storage device control, power management and etc.) and facilitating intercommunication between various hardware and software components of the interactive phone 104.

In one preferred embodiment, the display panel 404 is a touch-sensitive screen which allows the guests to access displayed information such as yellow pages, addresses, news, stock quotes and the like. The display panel 404 provides an input interface and an output interface between the interactive phone 104 and a guest. A display controller (not shown) receives and/or sends electrical signals from/to the display panel 404. The display panel 404 then displays visual outputs to the guest. The visual output may include graphics, text, icons, video, and any combination thereof (collectively termed “graphics”). In some embodiments, some or all of the visual outputs may correspond to user-interface objects.

The display panel 404 has a touch-sensitive surface, sensor or set of sensors that accepts input from users based on haptic and/or tactile contact. Usage of the display panel 404 is affected for example by touching and moving a pointer to the corresponding area on the display panel 404. The display panel 404 and the display controller (along with any associated modules and/or sets of instructions in memory) detect contact (and any movement or breaking of the contact) on the display panel 404 and converts the detected contact into interaction with the user-interface objects (e.g. one or more soft keys, icons, web pages or images) that are displayed on the display panel 404. In one embodiment, a point of contact between the display panel 404 and the user corresponds to a finger of the user.

The display panel 404 may use LCD (liquid crystal display) technology, or LPD (light emitting polymer display) technology, although other display technologies may be used in other embodiments. The display panel 404 and the display controller may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display panel 404.

The display panel 404 may have a resolution in excess of 100 dots-per-inch (dpi). In one embodiment, the display panel 404 has a resolution of approximately 160 dpi. The display panel 404 is preferably 8 inches by 8 inches in dimension or may be appropriately sized as desired. The guest may make contact with the display panel 404 using any suitable object or appendage, such as a stylus, a finger, and so forth. In some embodiments, the user interface is designed to work primarily with finger-based contacts and gestures, which are much less precise than stylus-based input due to the larger area of contact of a finger on the display panel 404. In certain other embodiments, the display controller translates the rough finger-based input into a precise pointer/cursor position or command for performing the actions desired by the guest. Optionally, a mouse ball may also be incorporated on the interactive phone 104 in a known manner to control the pointer on the display panel 404 for selecting the desired display information.

In addition, the display panel 404 may be elevated at an angle with respect to the base of the housing of the interactive phone 104 to enable easy viewing of the displayed contents by the guests. The angle of elevation for the display panel 404 is preferably adjusted at an angle substantially between thirty to seventy degrees. Yet in other embodiments, the angle of elevation is adjustable by the guests to suit their individual viewing preferences.

A phone handset 502 is supported on the housing in a conventional manner as illustrated. The phone handset 502 may be directly connected to the housing via an electrical cord, or alternatively, may be of the cordless type. In addition, the interactive phone 104 may also include a speaker phone function. Optionally, the interactive phone 104 can also be adapted to be connectible to any computer ports for interfacing the interactive phone 104 to a computer. The interactive phone 104 may also be installed with several universal serial bus (USB) ports (not shown). The USB ports may be useful for room guests who carry devices such as portable battery chargers that receive power via the USB ports. The interactive phone 104 further comprises a Registered-Jack-45 (RJ-45) connector and a RJ-11 telephone connector (all not shown). The RJ-45 connector enables the interactive phone 104 to be connected to the communications network 108 using category-5 cables which are typically employed for Ethernet connections. The RJ-11 telephone connector enables the interactive phone 104 to connect to the PSTN 114 via typical telephone wires. In addition, for functioning as an Internet WAP, the interactive phone 104 also comprises a wireless transceiver (e.g. a wireless RF transceiver) to wirelessly interface the interactive phone 104 to a computing device with a corresponding matching transceiver. The communication link between the computing device and the interactive phone 104 may be established using a communication protocol such as Bluetooth, Wireless Universal-Serial-Bus (WUSB), Wireless Firewire, Ultra-Wideband (UWB), Worldwide-Interoperability for Microwave Access (WiMAX) or Wireless Fidelity (Wi-Fi).

Voice data, multimedia data, and other data can be transmitted to and from the content database manager 102 and the interactive phone 104 via the Ethernet connection or via RF signals. Further, use of the Ethernet connection or RF signals for communication between the interactive phone 104 and the content database manager 102 enables VoIP communications or other types of communications to be integrated with the Internet 110 or a data network more cost-effectively.

Additionally, as the interactive phone 104 communicates with the content database manager 102 using the Ethernet-based connection or RF signals, the interactive phone 104 can be provided with less computing, processing and/or memory resources since the computing, processing and/or memory resources of the content database manager 102 may be used for any backend data processing. Such a client-server operation concept is known to those skilled in the art as thin-client computing. By using less computing, processing and/or memory resources, the fabrication and retail costs of the interactive phone 104 may also be reduced. For example, the interactive phone 104 may utilize a web browser (e.g. Apple Safari) that is installed on the content database manager 102 for accessing the Internet 110. It is to be appreciated that it is typically more cost-effective for the interactive phone 104 to mimic the functionalities of a computer with services such as e-mail, Internet access and portal features.

The interactive phone 104 may also include additional features to improve the quality and speed of phone services and/or ensure secure transmission of any data therefrom. For example, interactive phone 104 may include a digital signal processor to improve the sound quality of the voice transmission or hardware coders and communication circuitry to transmit alpha-numeric as well as voice data. The interactive phone 104 may also include means for converting analog to digital, generating sets or packets of digital data from voice signals and alpha-numeric inputs, and means for compressing the digital data to increase the speed and efficiency of the data transmission. An encryption encoder and a decryption decoder or equivalent software may also be provided in the interactive phone 104 to facilitate secure transmission of voice and alpha-numeric data. The interactive phone 104 may further optionally include an integrated video camera 504 or a connection interface for connecting an external video camera (not shown) to the interactive phone 104. The video camera 504 can be used for transmitting a video image of the guest using the interactive phone 104 for purposes such as video-conferencing.

The interactive phone 104 may also include software and hardware for performing gateway functions that provide bi-directional, real time communication interfaces between an IP-based or data network and a telephony network including mapping, translation, signaling and control of the media and signaling gateway. The provision of the gateway functions in the interactive phone 104 helps to mitigate the bottleneck effect since the interactive phone 104 includes in essence the originating gateway. Moreover, using the gateway functions may also help to reduce the cost of providing voice-over-data services via the interactive phone 104. Furthermore, the gateway functions also comprise a proxy server function that enables computing devices to use the interactive phone 104 as an Internet WAP. Yet additionally, the gateway functions include providing authentication for users of the computing devices before granting them Internet access through the interactive phone 104.

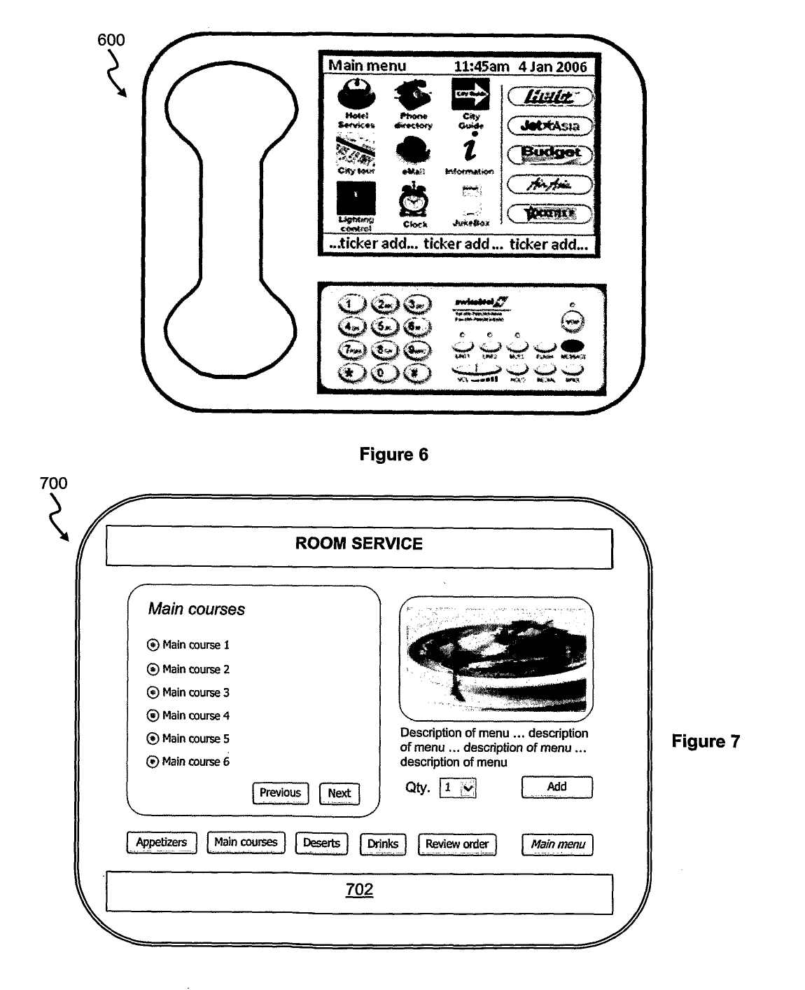

With reference to FIG. 6, the display panel 404 of the interactive phone 104 shows a home page (i.e. main menu) as displayed thereon to provide user selectable options related to different services provided by the hotel operator. The services may include telephone directory, housekeeping, room service, hotel entertainment, reminders, lighting control, room-climate control and the like. Additionally, the services may further include external online services related to travel package reservations, entertainment, news, radio, electronic mail and the like. The various features of the home page as displayed on the display panel 404 are customizable according to specific requirements (e.g. guest profiles and guest preferences). Customization of the home page is performed via the content manager 202 and may be made in respect of the choice of online services, advertising contents, type of user interfaces and the like.

A section of the display panel 404 may be assigned for displaying advertisements. As illustrated in FIG. 6, advertisements may continuously be streamed and displayed in a bottom margin on the display panel 404 as text, static images or video clips. Providing advertisement channels and various online services through the interactive phones 104 allows the hotel operators to generate revenues from sale of advertisement spaces and provision of online services. For instance, when a guest selects and orders a service provided by an external service provider through the interactive phone 104, the order is subsequently traced to the external service provider and a pre-agreed commission may then be paid to the hotel operator for facilitating the transaction.

FIGS. 7 to 12 are screen-captures of exemplary display pages of various services provided by the hotel operators and are accessible by the guests through the interactive phones 104. Further details of each display page are as provided herein below.

FIG. 7 shows a first display page 700 through which a guest may order room-services. Information on various meal items is shown on the first display page 700 and the guest may then submit a selection corresponding to his desired meal choice by simply touching the display panel 404 at an area which the selection for the particular meal is located. Subsequently, the selection is transmitted to the content database manager 102 and processed by the content manager 202. The content manager 202 dispatches an order for the meal as indicated by the selection to the room service department or the hotel's central kitchen to prepare and fulfill the order. In addition, a margin 702 is also pre-allocated at the bottom of the first display page 700 as shown. The margin 702 may be used for various purposes such as displaying text-based advertisements or making hotel announcements.

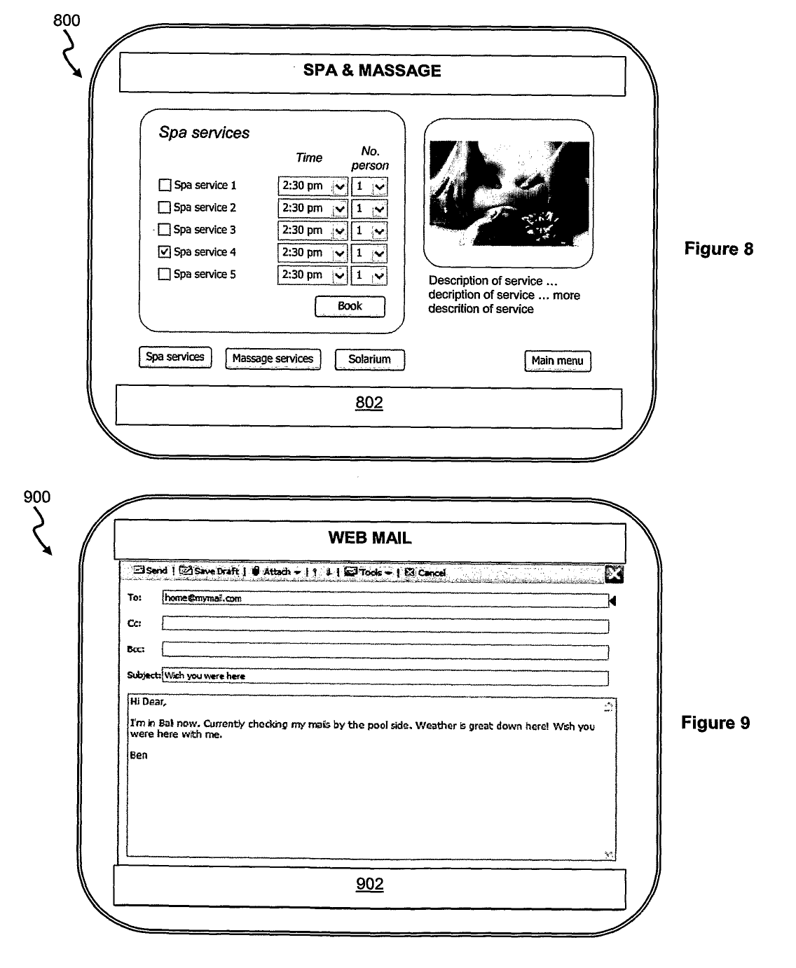

FIG. 8 shows a second display page 800 for ordering spa and massage services through which the guest may make an online reservation for a preferred time slot of his choice for a spa or massage session. The guest may choose the type of spa or massages he wishes to receive through the second display page 800. Similarly, the selection is transmitted to the content database manager 102 and processed by the content manager 202. An order corresponding to the selection is then dispatched to a service provider (e.g. a spa salon) to reserve a time slot for the spa/massage session. In addition, a margin 802 is also pre-allocated at the bottom of the second display page 800 as shown. The margin 802 may be used for various purposes such as displaying text-based advertisements or making hotel announcements.

FIG. 9 shows a third display page 900 for accessing emails. The third display page 900 enables the guest to access various online electronic web-mail sites such as Yahoo Mail, MSN Hotmail or Google Gmail. The guest first selects a desired link corresponding to a web-mail site from a list provided on the third display page 900. Alternatively, the guest may provide an appropriate hyperlink address for accessing a web-mail site of his choice. Typically, a login page is then displayed for the guest to enter his personal user identification and a password. Upon successful authentication by the relevant web-mail service provider, the guest is then able to access his email account to perform various web-mailing tasks (e.g. viewing new mail messages, composing new mail messages, sending mail messages, address book management and any other miscellaneous account management functions). The guest may activate a soft keyboard (not shown) on the display panel 404 for text input. The displayed soft keyboard may overlay a portion of the currently displayed content on the display panel 404 when being activated. In addition, the soft keyboard displayed may depend on the application context. For example, the user-interface displays a soft keyboard with numbers when numeric input is needed or expected. The user-interface displays a soft keyboard with letters when character input is needed or expected. The layout of the soft keyboard is preferably of the conventional QWERTY arrangement. In addition, the soft keyboard may be located in an area near the bottom of the display panel 404. Optionally, the positioning of the soft keyboard on the display panel 404 may be changed by the guest. In addition, there is pre-allocated a margin 902 at the bottom of the third display page 900 as shown. The margin 902 may be used for various purposes such as displaying text-based advertisements or making hotel announcements.

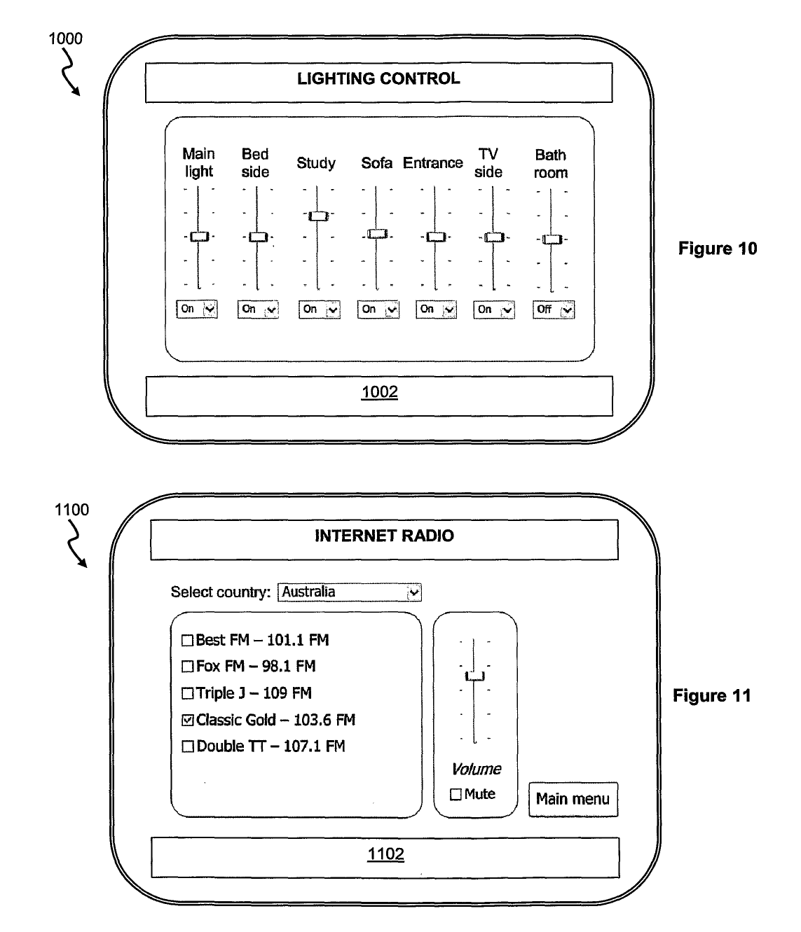

FIG. 10 shows a fourth display page 1000 for controlling lighting conditions in a hotel room. Through the fourth display page 1000, the guest is able to control the illumination intensity of various lighting locations (e.g. at the sofa, at the bed side or in the bath room) in the hotel room. The adjusted illumination settings may then be saved in a user-lighting profile corresponding to the guest's identity. The user-lighting profile is stored in a first database located on the content database manager 102. Alternatively, the first database may be stored in a specialized database server intended for such purposes. Consequently, the user-lighting profile is retrievable from the first database and the settings saved therein can be activated for the various lighting locations in a new hotel room occupied by the guest for his subsequent stay at the hotel. In addition, a margin 1002 is also pre-allocated at the bottom of the fourth display page 1000 as shown. The margin 1002 may be used for various purposes such as displaying text-based advertisements or making hotel announcements.

FIG. 11 shows a fifth display page 1100 for tuning into radio services digitally-streamed over the Internet 110. Through the fifth display page 1100, the guest may select a desired radio station from a provided list. The radio stations in the provided list preferably broadcast music of different genres. The respective radio station settings defined by the guest may then be saved in a user-radio-station profile corresponding to the guest's identity. The user-radio-station profile is stored in a second database located on the content database manager 102. Alternatively, the second database is stored in a specialized database server intended for such purposes. Consequently, the user-radio-station profile is retrievable from the second database and the settings saved therein may be activated by the guest for his subsequent stay at the hotel. In addition, a margin 1102 is also pre-allocated at the bottom of the fifth display page 1100 as shown. The margin 1102 may be used for various purposes such as displaying text-based advertisements or making hotel announcements.

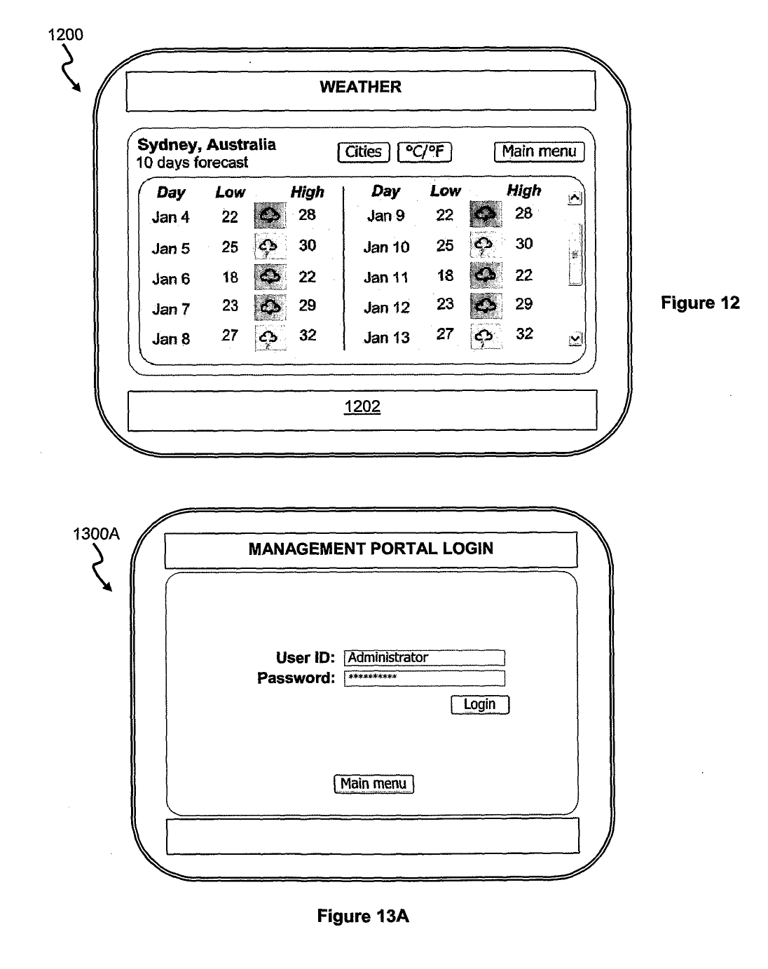

FIG. 12 shows a sixth display page 1200 for showing the weather forecast obtained from a weather information source. Accurate and up-to-date weather forecast information for major cities around the world is provided to the guest through the sixth display page 1200. Other optional services, such as providing a digital jukebox, may also be made available through the interactive phone 104. With reference to the digital jukebox service, a user-friendly and intuitive music-playback interface may be provided by the interactive phone 104 to enable the guest to make selections of songs from a provided list for his enjoyment in the hotel room. Digital copies of the listed songs are stored in a third database, preferably located on the content database manager 102. Alternatively, the third database is stored in a specialized database server intended for such purposes. The list of available songs may be updated periodically using the content manager 202. In addition, a margin 1202 is also pre-allocated at the bottom of the sixth display page 1200 as shown. The margin 1202 may be used for various purposes such as displaying text-based advertisements or making hotel announcements.

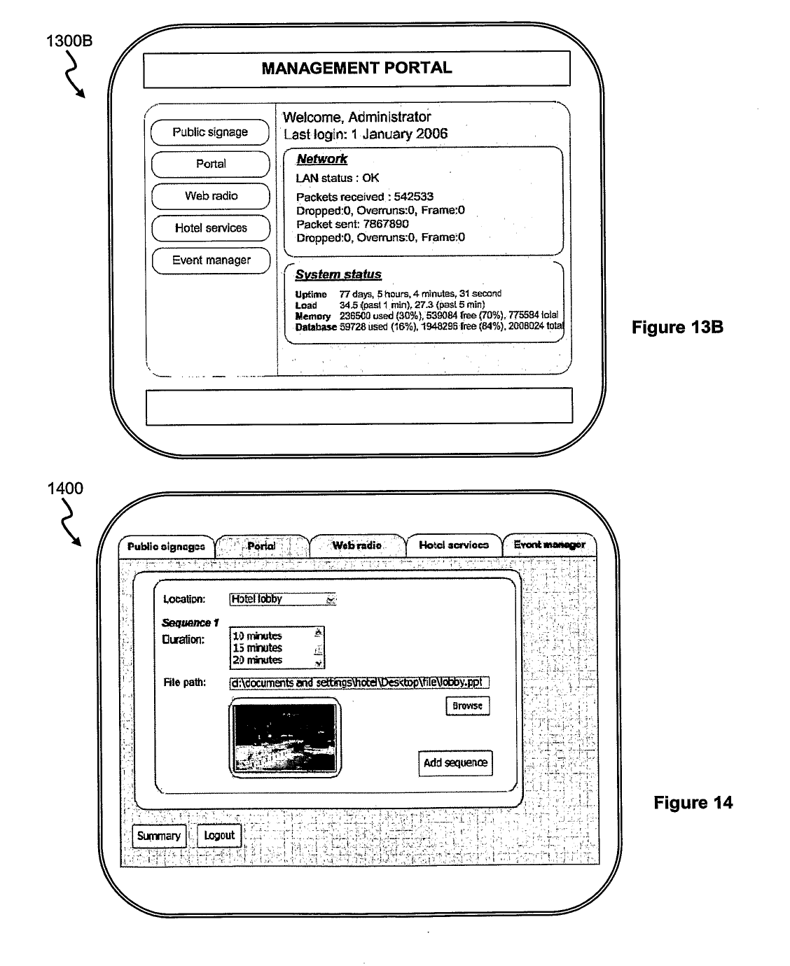

In order to manage the CMD system 100, a content administrator first needs to login to the content manager 202 through the administrator login page 1300A of the management portal as shown in FIG. 13A. At the administrator login page 1300A, the content administrator needs to provide a valid user-identifier together with a corresponding password in order to be successfully authenticated by the content manager 202 for logging thereinto. Thereafter, the content administrator is granted access to the main display page 1300B of the management portal as shown in FIG. 13B. The main display page 1300B provides the content administrator with hyperlinks access to other sub-display pages containing related administrative functions. The administrative functions provided in the sub-display pages allow the content administrator to view, update and amend the information/interactive content that are to be made available to the guests of the hotel through the interactive phones 104. As illustrated in FIG. 13B, the main display page 1300B provides five hyperlinks access to administrative functions for managing the following: digital signages 112, portal services, offered services, events scheduling and radio services. In addition, the main display page 1300B may also provide other information such as system status, network statistics and the like. The respective sub-display pages are further described in detail below.

FIG. 14 shows a seventh display page 1400 in the management portal for managing the digital signages 112 in the hotel. On the seventh display page 1400, the content administrator may specific settings related to the display of advertisements/information on the digital signages 112. The settings include specifying locations for display of the advertisements/information, the display sequences, the display durations, image or video clips selection for the advertisements/information and the like.

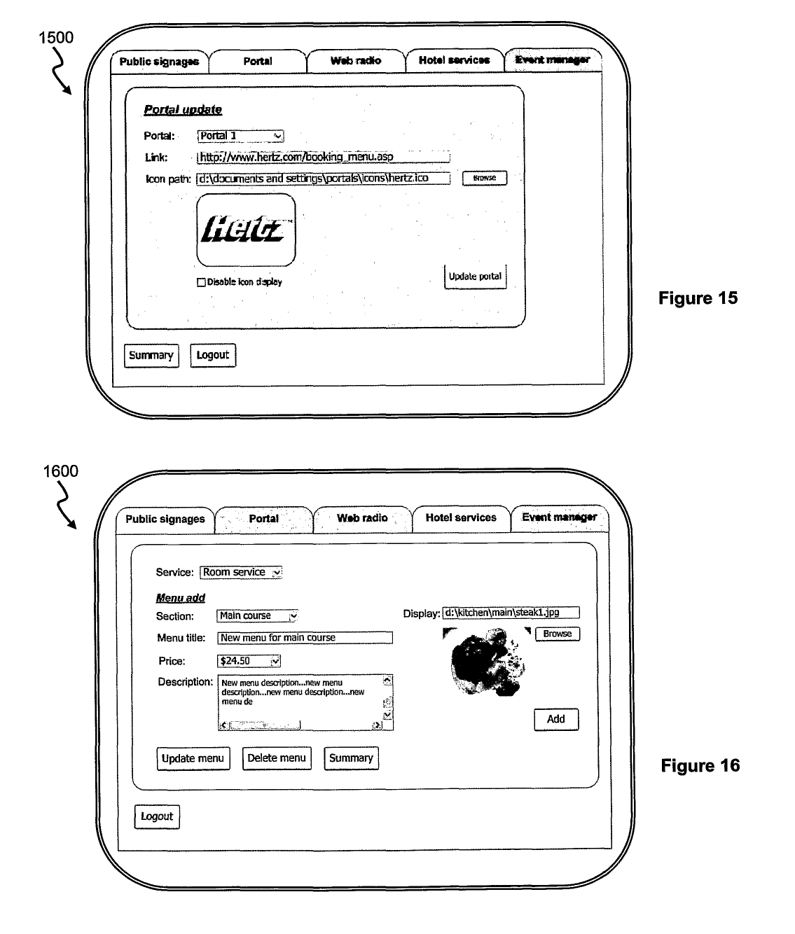

FIG. 15 shows an eighth display page 1500 in the management portal for managing the list of available portal services to be shown on the display panels 404 of the interactive phones 104. The content administrator may add new portal services to content to be shown on the display panel 404 which the guests may order through the interactive phone 104. Existing portal services included in the content may also be deleted or modified as well. The types of portal services for inclusion into the content may include, for example, car rental services, ticket reservations, Internet radio, online shopping and the like. Through the eighth display page 1500, the content administrator may specify relevant settings related to the display of the portal services such as the type of display icons and the hyperlinks for accessing the portal services.

FIG. 16 shows a ninth display page 1600 in the management portal for managing the selection of available services provided by the hotel. The available services may include room services, laundry services, Internet access services, baggage services, spa services and the like. Through the ninth display page 1600, the content administrator may modify or add menu selections, including prices, descriptions of menu items and the corresponding display photographs thereof. Similarly, other service directories of the hotel may also be modified according to an “on-required” basis without having to incur any unnecessary costs for printing menu brochures whenever changes to the menus are required.

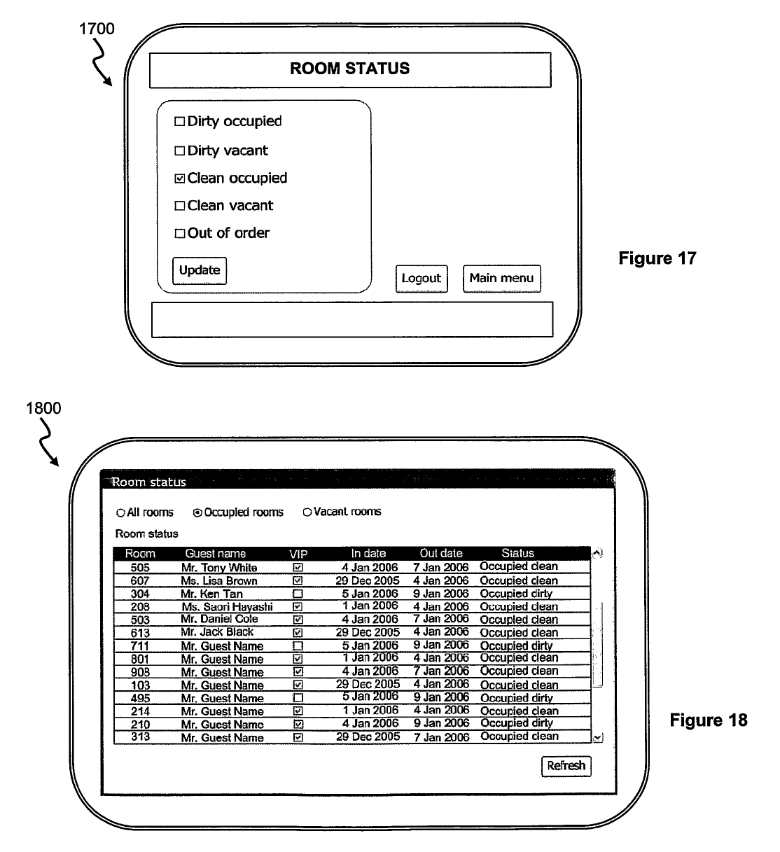

FIG. 17 shows a tenth display page 1700 in the management portal for indicating a current room status of the hotel rooms. During or after housekeeping the hotel rooms, a hotel housekeeping staff may access the tenth display page 1700 from the interactive phones 104 located in the respective hotel rooms to update the current room status. As shown in FIG. 17, the options available for indicating a current room status comprise the following: “dirty occupied”, “dirty vacant”, “clean occupied”, “clean vacant” and “out of order”. Subsequently, the updated room status information of all the hotel rooms is then transmitted to the content manager 202 to be recorded and stored in a fourth database located therein. Alternatively, the fourth database is stored in a specialized database server intended for such purposes. Moreover, the content manager 202 may be configured such that the room status of the hotel rooms can be collated and viewable via an information display page intended for such purposes. In addition, summary reports of the room status may also be generated from the information display page. More details are provided in FIG. 18.

FIG. 18 shows an eleventh display page 1800 in the management portal for presenting a summary listing of the room status of the hotel rooms. Through the eleventh display page 1800, the guest information of the guests staying in the respective hotel rooms is retrievable from the content manager 202. Yet further, summary reports of all the hotel rooms (i.e. vacant and occupied) may also be generated separately. The eleventh display page 1800 is automatically updated and may be refreshed periodically after a predetermined period (e.g. every ten minutes), showing the latest room status information of all the hotel rooms thereafter. In this manner, the latest room status information is made available to the front-desk hotel staff which then may aid them in management of the hotel occupancy.

In addition to generating summary reports for the statuses of the hotel rooms, the content manager 202 may also be configured to generate billing reports/receipts for guests who have requested for the hotel services through either the interactive phones 104 and/or conventional ordering means (e.g. room service hotline). Consequently, the billing reports/receipts may be made available to the guests or the hotel operator as an indication of the expenses accrued to date by the guests.

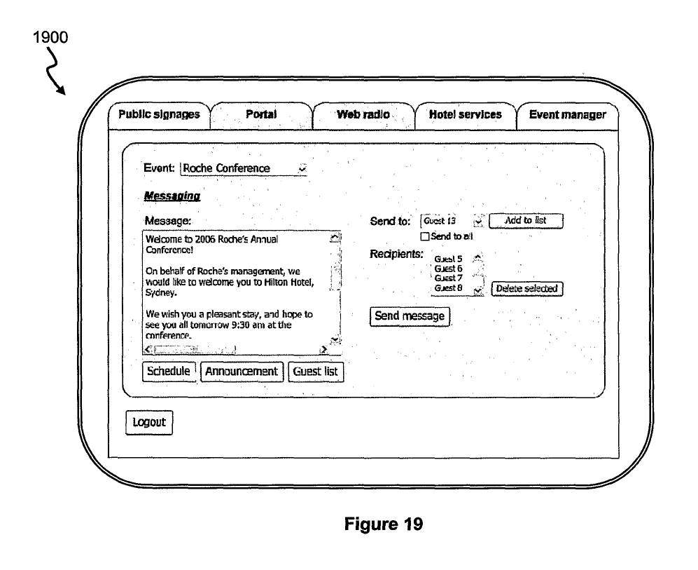

FIG. 19 shows a twelfth display page 1900 in the management portal for managing events that are hosted within the hotel. Through the twelfth display page 1900, an event coordinator may customize the available services (e.g. messages, announcements, reminders, advertisements or online services) for a group of guests participating in a corresponding event (e.g. conference, group tour, corporate retreat or the like) that is to be held in the hotel premises or is otherwise organized by the hotel. In addition, the event coordinator may further predefine a list containing the group of guests participating in the event so that the event coordinator may disseminate customized event-related messages to the guests through the interactive phones 104 provided in their hotel rooms. Yet further, the event coordinator may also use the twelfth display page 1900 to broadcast announcements regarding details of the events through the digital signages 112.

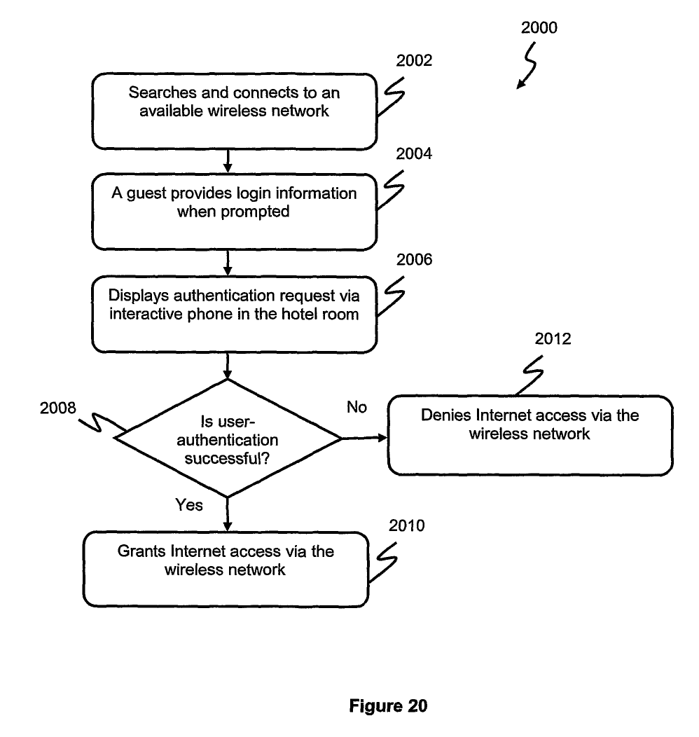

FIG. 20 shows a flow diagram illustrating an exemplary user authentication method 2000 for granting Internet access to computing devices employing the interactive phone 104 as an Internet WAP. A guest first activates his computing device that is equipped with wireless capability and the computing device then automatically searches for any available wireless networks in the vicinity (block 2002). Upon detection of available wireless networks, the computing device attempts to connect, preferably, to a wireless network provided by the hotel operator since the signal strength of such a wireless network is likely to be the strongest among all detected wireless network in the vicinity. We refer to this wireless network as the default network hereon. To login to the default network, the guest uses a web browser (e.g. Mozilla Firefox) in which a login page for connecting to the default network is presented thereon to the guest. On the login page, the guest then provides the necessary login information (e.g. a user-identifier such as the hotel room number, a password or the like) (block 2004) in order to connect to the default network.

The login information is then transmitted to the content manager 102 for verification and which also further responds with an authentication request. The authentication request is displayed on a corresponding interactive phone 104 located in the hotel room (block 2006) as indicated previously in the login information provided by the guest. For example, the authentication request may be presented as a pop-up window on the display panel 404 of the interactive phone 104, prompting the user to provide a response. It is to be appreciated that the authentication request may also be realizable and presentable in other forms/means by making suitable modifications thereto. The guest completes the authentication process by responding to the incoming authentication request. A decision on whether to grant Internet access to the guest is then made by the user authentication method 2000 upon receipt of the guest's response (block 2008).

Accordingly, if the login information is correct and the response is provided, the guest is then able to access the Internet access on his computing device via the default network through use of the interactive phone 104 as an Internet WAP (block 2010). Conversely, if no response is received at the interactive phone 104 in the hotel room as indicated in the login information provided previously, the authentication process is considered unsuccessful or incomplete. Consequently, the guest is denied of Internet access (block 2012). Subsequently, if a group of guests operating a plurality of computing devices located in a particular hotel room requires concurrent access to the Internet 110, each guest operating the corresponding computing device needs to be verified using the user authentication method 2000 before Internet access via the default network may be granted thereto.

Additionally, a further embodiment of the invention is also realizable as computer readable code (i.e. programming instructions) on a computer readable storage medium. The computer readable storage medium is any data storage device that can store data which can thereafter be read by a computer system, including both transfer and non-transfer devices. Examples of the computer readable storage medium include read-only memory, random-access memory, CD-ROMs, Flash memory cards, DVDs, magnetic tape, optical data storage devices, and carrier waves. The computer readable storage medium can also be distributed over network-coupled computer systems so that the computer readable code is stored and executed in a distributed fashion.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1-36. (canceled)

37. A content management and delivery system for use in a hospitality establishment, comprising:
a plurality of communication devices located in a plurality of rooms, each of the plurality of communication devices having a display panel for enabling haptic interaction with data displayed thereon, the data including a plurality of user selectable options including a plurality of services provided by at least one of an operator of the hospitality establishment and an external service provider, the data being customizable to provide the plurality of user selectable options for facilitating user interaction therewith, and
a content server coupled to the plurality of communication devices,
wherein at least one of the plurality of communication devices is to receive the data from the content server, generate a response corresponding to a user interaction with the data displayed on the display panel and transmit the response to the content server.

38. The system of claim 37, wherein the at least one of the plurality of communication devices is to perform a plurality of gateway functions including a proxy server function, and the at least one of the plurality of communication devices includes means for establishing a wireless communication link with at least one computing device, the at least one computing device being connectible to Internet through the at least one of the plurality of communication devices employed as an Internet wireless access point (WAP), and
wherein the at least one of the plurality of communication devices is to provide a user authentication function for authenticating a user before granting Internet access to the at least one computing device.

39. The system of claim 38, wherein the at least one of the plurality of communication devices further includes a Registered-Jack-45 (RJ-45) connector for facilitating connection to an Internet Protocol (IP) based network.

40. The system of claim 37, wherein the content server is to generate a plurality of reports based on a plurality of responses received through the plurality of communication devices, the plurality of reports including a management report and a billing receipt, wherein the billing receipt includes expenses accrued to at least one user.

41. The system of claim 37, wherein the content server is to store at least one of the plurality of received responses associated with a user profile for subsequent retrieval and activation, the at least one of the plurality of received responses includes one of lighting control and room-climate control.

42. The system of claim 37, wherein the plurality of services provided by the operator of the hospitality establishment include at least one of telephone directory, housekeeping, room service, entertainment, reminders, lighting control and room-climate control.

43. The system of claim 42, wherein the plurality of services provided by the external service provider includes at least one of travel package reservations, entertainment, news, radio, and electronic mail.

44. The system of claim 37, wherein the plurality of communication devices include means for making telephone calls through a public switched telephone networks (PSTN) or an Internet Protocol (IP) based network depending on a user selection.

45. The system of claim 37, wherein the data displayed is at least two of an advertisement, a multimedia file, a video clip and an electronic message.

46. The system of claim 37, wherein the plurality of communication devices include a phone appliance capable of providing Internet access thereon and capable of being employed as an Internet wireless access point (WAP).

47. A content management and delivery method for a hospitality establishment, comprising:
displaying data on a display panel of at least one of a plurality of communication devices which are located in a plurality of rooms, the display panel for enabling haptic interaction with the data displayed thereon, the data including a plurality of user selectable options including a plurality of services provided by at least one of an operator of the hospitality establishment and an external service provider, the data being customizable to provide the plurality of user selectable options for facilitating user interaction therewith, the plurality of communication devices being coupled to a content server, the data being received from the content server;
generating a response corresponding to a user interaction with the data displayed on the display panel; and
transmitting the response to the content server.

48. The method of claim 47, wherein the at least one of a plurality of communication devices is to perform a plurality of gateway functions including a proxy server function, and the at least one of the plurality of communication devices includes means for establishing a wireless communication link to a computing device, the computing device being connectible to Internet through the at least one of the plurality of communication devices employed as an Internet wireless access point (WAP), the method further comprising providing a user authentication function by the at least one of the plurality of communication devices for authenticating a user before granting Internet access to the at least one computing device.

49. The method of claim 47, further comprising: generating a plurality of reports based on a plurality of responses received through the plurality of communication devices, the plurality of reports including a management report and a billing receipt, wherein the billing receipt includes expenses accrued to at least one user.

50. The method of claim 47, further comprising: storing at least one of the plurality of received responses associated with a user profile for subsequent retrieval and activation, wherein the at least one of the plurality of received responses includes one of lighting control and room-climate control.

51. The method of claim 47, wherein the plurality of services provided by the operator of the hospitality establishment include at least one of telephone directory, housekeeping, room service, entertainment, reminders, lighting control and room-climate control.

52. The method of claim 51, wherein the plurality of services provided by the external service provider includes at least one of travel package reservations, entertainment, news, radio, and electronic mail.

53. The method of claim 47, further comprising making telephone calls using the at least one of the plurality of communication devices through a public switched telephone networks (PSTN) or an Internet Protocol (IP) based network depending on a user selection.

54. The method of claim 47, wherein the data displayed is at least two of an advertisement, a multimedia file, a video clip and an electronic message.

55. The method of claim 47, wherein the plurality of communication devices include a phone appliance capable of providing Internet access thereon and capable of being employed as an Internet wireless access point (WAP).
